(19) United States
(12) Patent Application Publication
(10) Pub. No.: US 2019/0064440 A1
(43) Pub. Date: Feb. 28, 2019

(54) OPTICAL FIBER CUTTER

(71) Applicant: SEI Optifrontier Co., Ltd., Yokohama-shi, Kanagawa (JP)

(72) Inventors: Tsuyoshi TADA, Yokohama-shi, Kanagawa (JP); Masahiro HASEGAWA, Yokohama-shi, Kanagawa (JP); Yoshiyuki NISHIZAWA, Yokohama-shi, Kanagawa (JP)

(73) Assignee: SEI Optifrontier Co., Ltd., Yokohama-shi, Kanagawa (JP)

(21) Appl. No.: 16/080,050

(22) PCT Filed: Jan. 30, 2017
(86) PCT No.: PCT/JP2017/003193

§ 371 Date: Aug. 27, 2018

(30) Foreign Application Priority Data
Feb. 29, 2016 (JP) 2016-037330

(51) Int. Cl. G02B 6/25

(52) U.S. Cl. CPC G02B 6/25

(57) ABSTRACT

An optical fiber cutter 1 includes a cutter base body 3, a slider 7 movably provided on the cutter base body 3, a blade member 23 provided on the slider 7, an object 30 to be detected provided on either one of the cutter base body 3 and the slider 7, a sensor 32 provided on the other of the cutter base body 3 and the slider 7 and detecting the object 30 to be detected, a controller 34 that, on the basis of the detection results of the sensor 32, calculates the number of movements of the slider 7 to a predetermined position and stores the calculated number, and a display unit 36 that displays the number of movements of the slider 7 to the predetermined position calculated by the controller 34.

### TECHNICAL FIELD

The present invention relates to an optical fiber cutter.

### BACKGROUND ART

The optical fiber cutter that is disclosed in Patent Literature 1 is known as an example of optical fiber cutters according to the related art. The optical fiber cutter disclosed in Patent Literature 1 is provided with a cutter base body including a holder guide portion positioning a fiber holder holding an optical fiber, a slider movably attached to the cutter base body and including a blade member scratching the optical fiber, a cutter lid body attached to the cutter base body to be openable and closable and moving the slider back to an initial position by being closed with respect to the cutter base body, a count display mechanism provided on the cutter base body for counting and display of the number of slider returns to the initial position, and control means for mechanically controlling the count display mechanism such that the count operation by the count display mechanism is activated only when the fiber holder is set in the holder guide portion.

### CITATION LIST

### Patent Literature

Patent Literature 1: Japanese Unexamined Patent Publication No. 2013-41042

### SUMMARY OF INVENTION

### Technical Problem

In the optical fiber cutter according to the related art, the number of slider returns to the initial position, that is, the number of blade member rotations is mechanically detected. Accordingly, in the optical fiber cutter according to the related art, a mechanism mechanically resetting the count number is required for the count to be reset, which may result in a complex structure. In addition, in the optical fiber cutter according to the related art, no integrated number obtained by count number integration can be stored since the count number is mechanically reset.

An object of an aspect of the present invention is to provide an optical fiber cutter that can be improved in terms of performance with a simple configuration.

### Solution to Problem

An aspect of the present invention relates to an optical fiber cutter cutting an optical fiber. The optical fiber cutter includes a cutter base body, a slider movably provided on the cutter base body, a blade member provided on the slider, an object to be detected provided on either one of the cutter base body and the slider, a sensor provided on the other of the cutter base body and the slider and detecting the object to be detected, a controller that, on the basis of the detection results of the sensor, calculates the number of movements of the slider to a predetermined position and stores the calculated number, and a display unit that displays the number of movements calculated by the controller.

### Advantageous Effects of Invention

According to an aspect of the present invention, performance improvement can be achieved with a simple configuration.

### BRIEF DESCRIPTION OF DRAWINGS

FIG. 1 is a perspective view illustrating an optical fiber cutter according to an embodiment.

FIG. 2A is a front view illustrating a time when a slider is at an initial position.

FIG. 2B is a perspective view illustrating the time when the slider is at the initial position.

FIG. 3A is a front view illustrating a time when the slider is at a cut initiation position.

FIG. 3B is a perspective view illustrating the time when the slider is at the cut initiation position.

FIG. 4 is a block diagram illustrating the configuration of a count mechanism.

FIG. 5A is a front view illustrating a cutter base body where a magnetic sensor is provided.

FIG. 5B is a perspective view illustrating the cutter base body where the magnetic sensor is provided.

FIG. 6A is a diagram illustrating the positions of the magnetic sensor and a magnet at the time when the slider is at the initial position.

FIG. 6B is a diagram illustrating the positions of the magnetic sensor and the magnet at the time when the slider is at the cut initiation position.

FIG. 7A is a conceptual diagram illustrating how an optical fiber is scratched by the optical fiber cutter illustrated in FIG. 1.

FIG. 7B is a conceptual diagram illustrating how the optical fiber is scratched by the optical fiber cutter illustrated in FIG. 1.

FIG. 7C is a conceptual diagram illustrating how the optical fiber is scratched by the optical fiber cutter illustrated in FIG. 1.

FIG. 7D is a conceptual diagram illustrating how the optical fiber is scratched by the optical fiber cutter illustrated in FIG. 1.

### DESCRIPTION OF EMBODIMENTS

### Description of Embodiment of Present Invention

Firstly, an embodiment of the present invention will be described by listing.

An aspect of the present invention relates to an optical fiber cutter cutting an optical fiber. The optical fiber cutter includes a cutter base body, a slider movably provided on the cutter base body, a blade member provided on the slider, an object to be detected provided on either one of the cutter base body and the slider, a sensor provided on the other of the cutter base body and the slider and detecting the object to be detected, a controller that, on the basis of the detection results of the sensor, calculates the number of movements of the slider to a predetermined position and stores the calculated number, and a display unit that displays the number of movements calculated by the controller.

In this optical fiber cutter, the object to be detected is detected by the sensor and the number of movements of the slider to the predetermined position, that is, the number of cuts of the optical fiber by the blade member is calculated on the basis of the detection results and stored. Since the number of movements of the slider to the predetermined position is calculated by the controller as described above, the count number can be reset with ease and the integrated number of the count numbers can be stored. Accordingly, the performance of the optical fiber cutter can be improved with a simple configuration.

In one embodiment, the cutter base body may include a holder guide portion defining a position of a fiber holder holding the optical fiber, a holder detector may be provided for detection of disposition of the fiber holder in the holder guide portion, and the controller may calculate the number of movements of the slider to a cutter initiation position in a case where the fiber holder is detected by the holder detector. In this configuration, the controller calculates the number of movements only when the fiber holder is set in the holder guide portion. As a result, the controller does not calculate the number of movements of the slider to the predetermined position, even if the slider is moved, in a state where the fiber holder is not set in the holder guide portion. As a result, it is possible to calculate the number of movements of the slider to the predetermined position only when the optical fiber is actually cut.

In one embodiment, the holder detector may have a moving portion moved by the fiber holder when the fiber holder is disposed in the holder guide portion and an electric contact point energized or shut off in conjunction with the movement of the moving portion, and may detect the disposition of the fiber holder in the holder guide portion when the electric contact point is energized or shut off. In this configuration, the presence or absence of the fiber holder in the holder guide portion can be precisely detected.

In one embodiment, the object to be detected may be provided on the slider and the sensor may be provided on the cutter base body. In this configuration, the sensor requiring wiring or the like is provided on the cutter base body, and thus the configuration can be simpler than in a case where a sensor is provided on the slider as a moving body.

In one embodiment, the controller may store a count value as the number of movements of the slider to the predetermined position in a first period and store an integrated value as the number of movements of the slider to the predetermined position in a second period including the count value and the display unit may display at least one of the count value and the integrated value. As a result, the count value and the integrated value can be displayed on the display unit.

In one embodiment, the object to be detected may be a magnetic body and the sensor may be a magnetic sensor. In this configuration, the sensor is capable of precisely detecting the object to be detected.

In one embodiment, the sensor may have a shielding member magnetically shielding a part other than a part facing the object to be detected. As a result, the sensor is unlikely to be affected by a magnetic field other than the object to be detected. Accordingly, the sensor is capable of precisely detecting the object to be detected. As a result, the number of movements of the slider to the predetermined position can be accurately calculated.

In one embodiment, the blade member may be rotatably provided on the slider and rotate by a predetermined angle in one direction when the slider reaches the predetermined position. As a result, the number of rotations of the blade member resulting from a movement of the slider to the predetermined position can be calculated.

### Details of Embodiment of Present Invention

Hereinafter, an embodiment of the present invention will be described in detail with reference to accompanying drawings. In the description of the drawings, the same or corresponding elements are denoted by the same reference numerals, and redundant description is omitted.

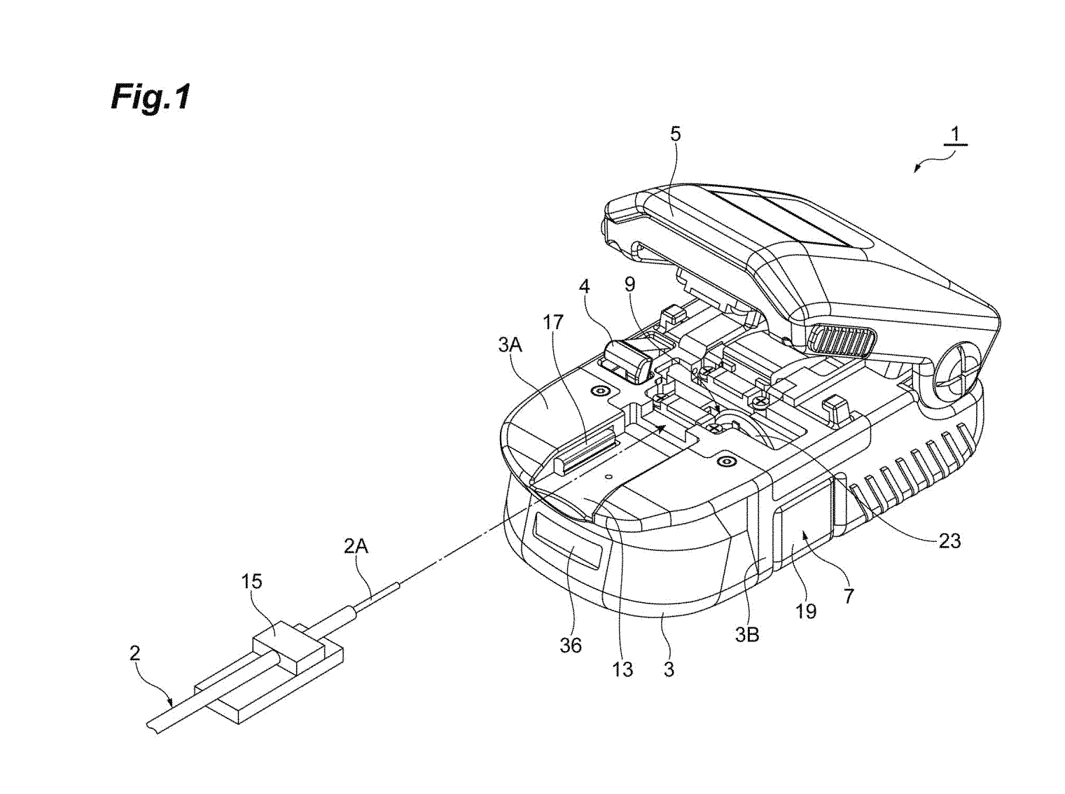

As illustrated in FIG. 1, an optical fiber cutter 1 is a device cutting a glass fiber 2A exposed by the coating at the tip part of an optical fiber 2 being removed.

The optical fiber cutter 1 is provided with a cutter base body 3, a cutter lid body 5, a slider 7, a blade portion 9, and a count mechanism 11.

The cutter base body 3 has a holder guide portion 13. The holder guide portion 13 is provided on an upper surface 3A of the cutter base body 3. The holder guide portion 13 defines the position of a fiber holder 15 holding the optical fiber 2 that should be cut. The holder guide portion 13 has a substantially rectangular recessed shape. A claw member (holder detector, moving portion) 17 is disposed on one side surface side of the holder guide portion 13. In a normal state where the fiber holder 15 is not set in the holder guide portion 13, the claw member 17 remains protruding because of the biasing force of a spring (not illustrated). Once the fiber holder 15 is set in the holder guide portion 13, the claw member 17 is pushed and retracted against the biasing force of the spring.

The cutter lid body 5 is attached to the cutter base body 3 to be openable and closable. Specifically, the cutter lid body 5 is pivotably connected via a shaft portion (not illustrated) extending in the width direction of the cutter base body 3 in the rear end portion of the cutter base body 3.

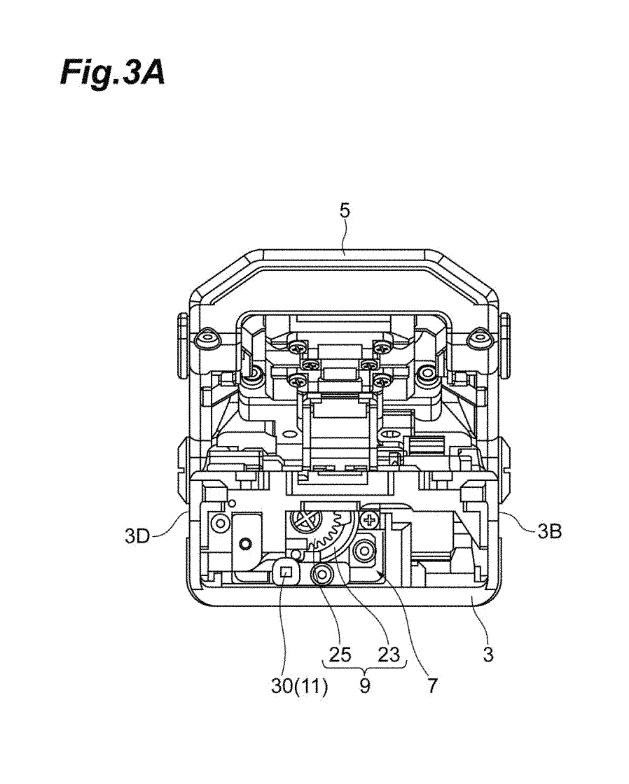

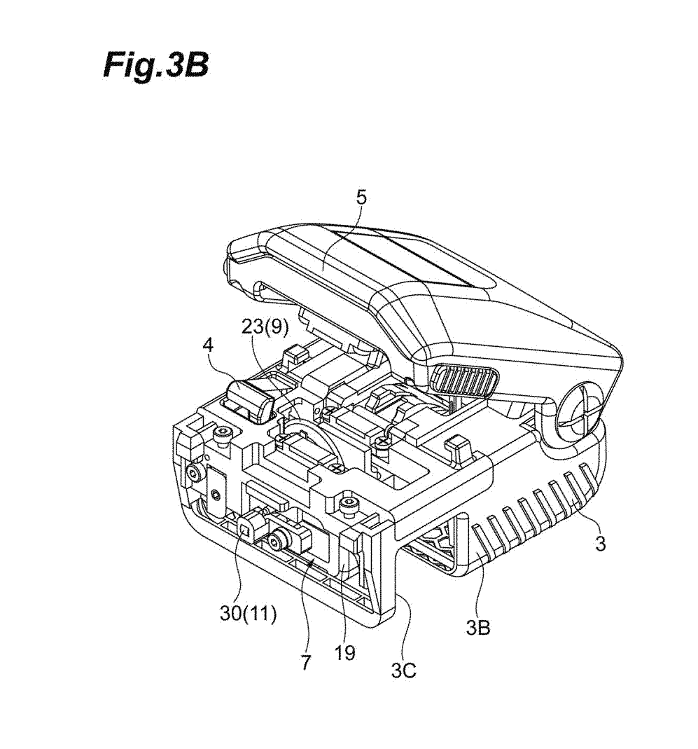

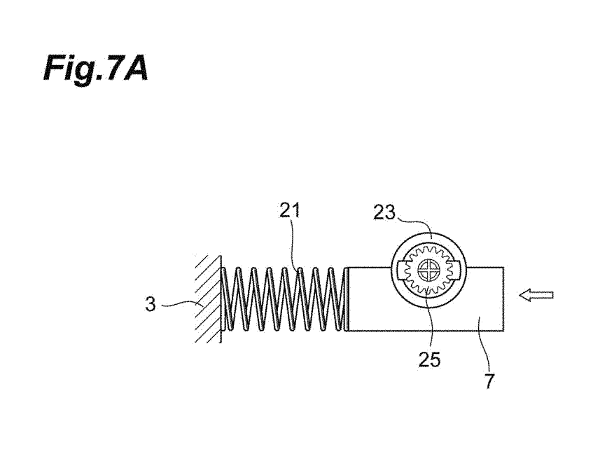

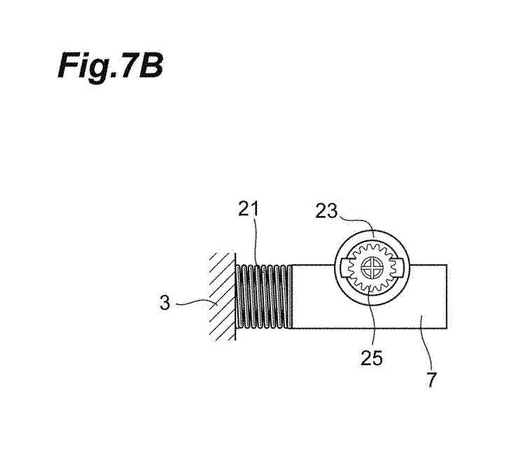

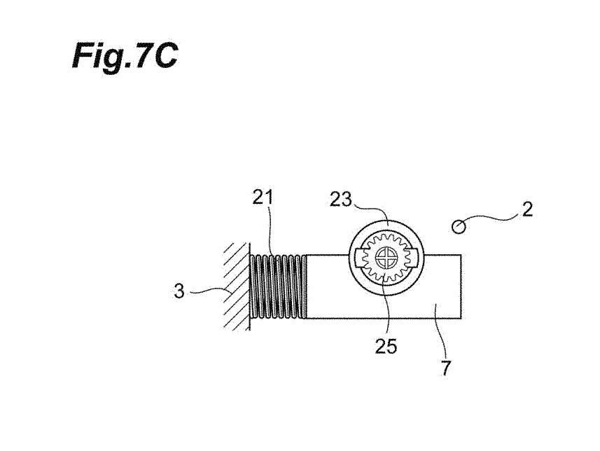

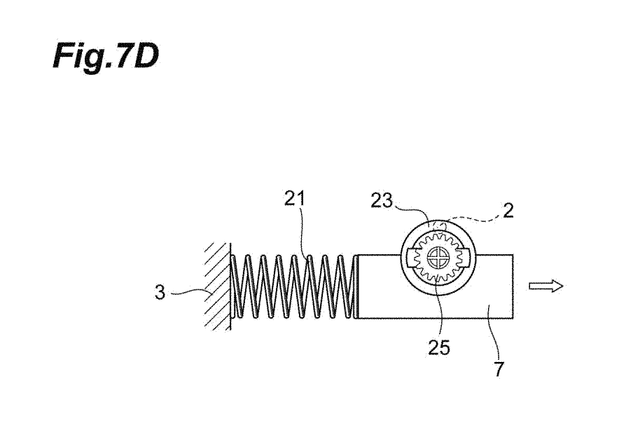

The slider 7 is provided behind the holder guide portion 13 in the cutter base body 3. As illustrated in FIGS. 3A and 3B, the slider 7 is movable in the width direction of the cutter base body 3. A push-in portion 19 is provided in one end portion of the slider 7. An open portion 3C for exposing the push-in portion 19 is formed in one side surface 3B of the cutter base body 3. A spring 21 (refer to FIGS. 7A to 7D) biasing the slider 7 to the open portion 3C side is provided between the other end portion of the slider 7 and the other side surface 3D of the cutter base body 3. Normally, the slider 7 is at the initial position thereof as illustrated in FIG. 1 because of the biasing force of the spring 21.

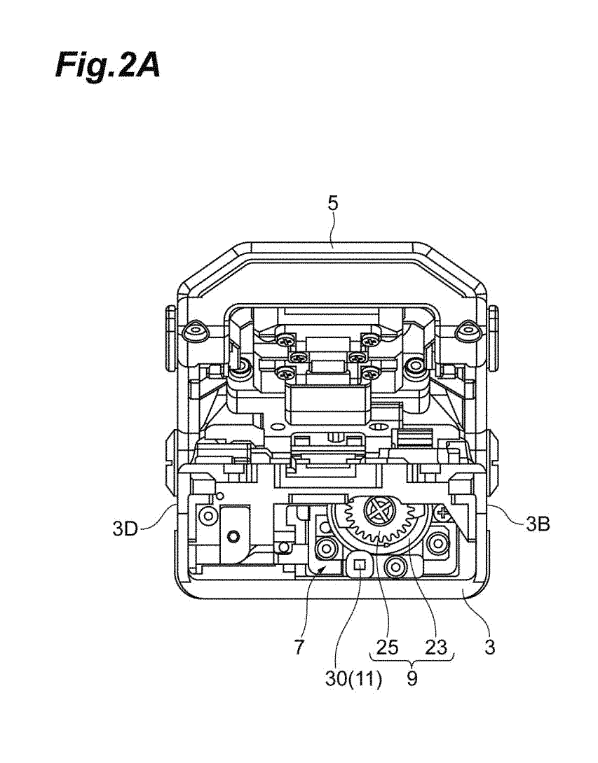

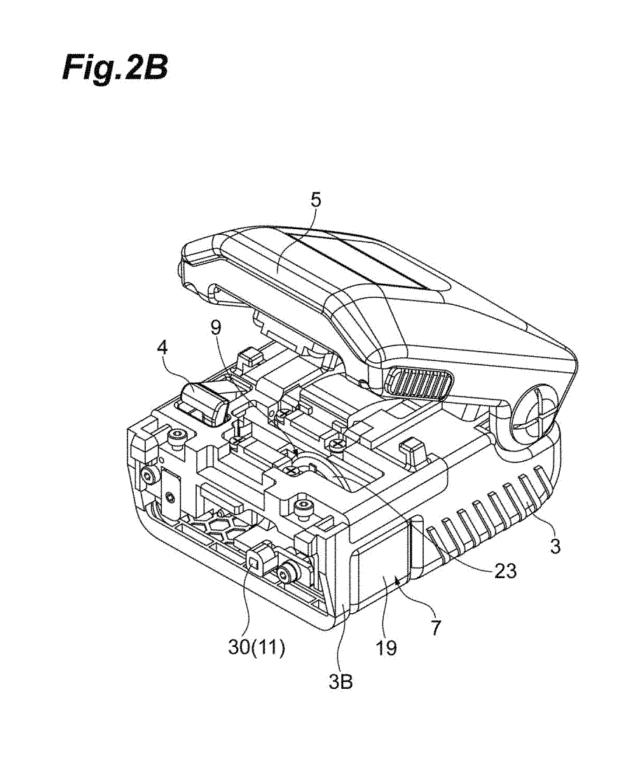

As illustrated in FIGS. 2A, 2B, 3A, and 3B, the blade portion 9 has a blade member 23 and a rotating body 25. The blade member 23 is a disk-shaped blade scratching the glass fiber 2A of the optical fiber 2. The blade member 23 is provided on the slider 7 to be rotatable in one direction (counterclockwise direction when viewed from the front of the cutter base body 3 in the present embodiment).

The rotating body 25 is attached to the blade member 23. The rotating body 25 rotates together with the blade member 23. In the present embodiment, the rotating body 25 is a circular gear. As illustrated in FIG. 3A, the rotating body 25 is rotated in one direction by abutting against an arm (not illustrated) when the slider 7 reaches a cut initiation position (predetermined position). In other words, the blade member 23 rotates when the slider 7 reaches the cut initiation position.

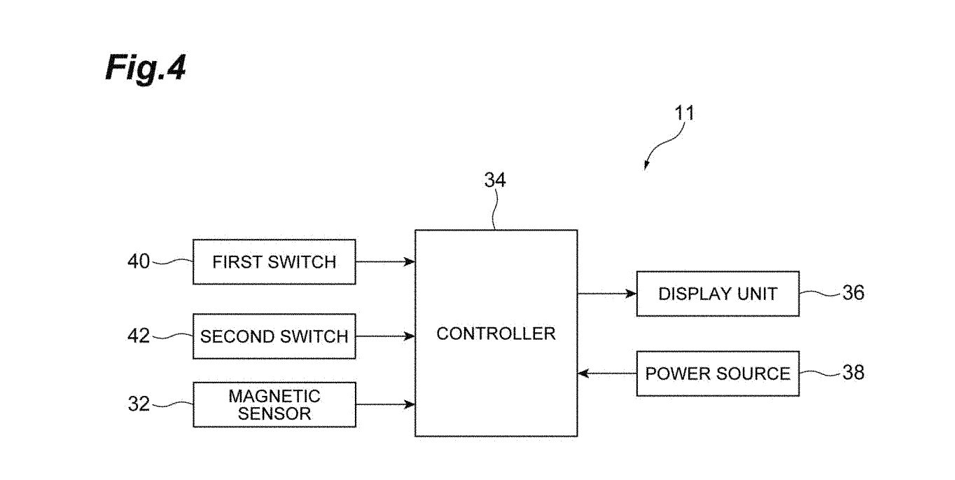

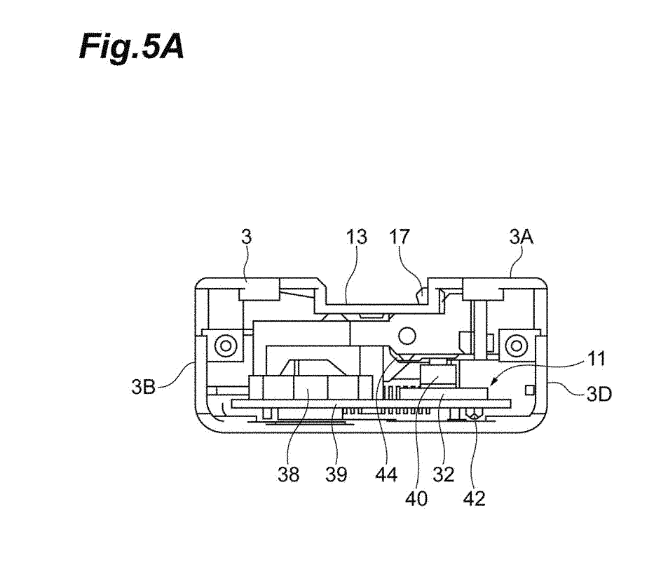

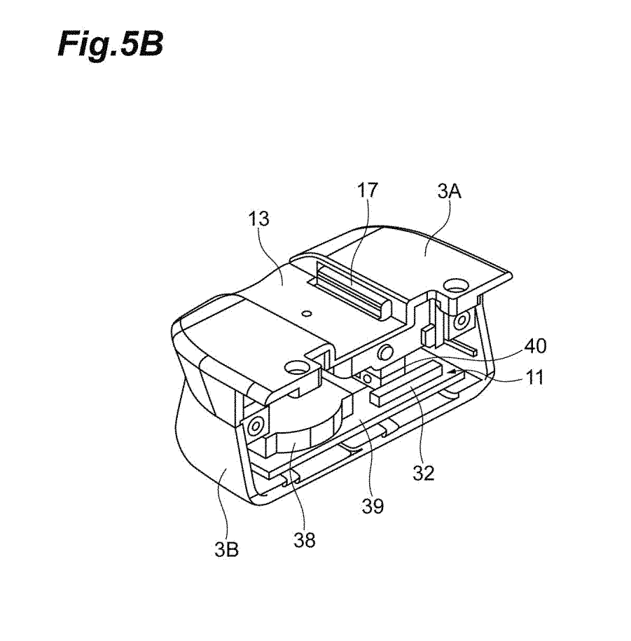

As illustrated in FIGS. 4, 5A, and 5B, the count mechanism 11 is provided with a magnet (object to be detected, magnetic body) 30, a magnetic sensor (sensor) 32, a controller 34, a display unit 36, and a power source 38. In the present embodiment, the magnetic sensor 32, the controller 34, the display unit 36, and the power source 38 are provided on a substrate 39 and unitized.

The magnet 30 is provided on the slider 7. As illustrated in FIGS. 2A, 2B, 3A, and 3B, the magnet 30 is disposed in the lower portion of the slider 7 and provided on the front side of the cutter base body 3. The magnet 30 moves in the width direction of the cutter base body 3 as the slider 7 moves.

The magnetic sensor 32 detects the magnet 30. The magnetic sensor 32 is provided on the cutter base body 3. The magnetic sensor 32 is disposed at a position facing the magnet 30 when the slider 7 reaches the cut initiation position. In other words, the magnetic sensor 32 detects the slider 7 reaching the cut initiation position. The magnetic sensor 32 outputs a detection signal indicating the presence or absence of the detection of the magnet 30 to the controller 34.

On the basis of the detection results of the magnetic sensor 32, the controller 34 calculates the number of movements of the slider 7 to the cut initiation position and stores the calculated number. In other words, the controller 34 calculates the number of rotations of the blade member 23 (number of cuts of the optical fiber 2 by the blade member 23) and stores the calculated number. The controller 34 is, for example, a programmable IC.

A first switch (holder detector, electric contact point) 40 and a second switch 42 are electrically connected to the controller 34. As illustrated in FIG. 5A, the first switch 40 is mechanically connected to the claw member 17 via a connecting member 44. The first switch 40 is turned ON (energized) by being pressed by the connecting member 44 once the fiber holder 15 is set in the holder guide portion 13 and the claw member 17 is pressed and retracted by the fiber holder 15. The first switch 40 is turned OFF (shut off) when the claw member 17 is not pressed by the fiber holder 15. Once turned ON, the first switch 40 outputs an ON signal to the controller 34.

The second switch 42 is provided at a position where the second switch 42 can be pressed by an operator. In the present embodiment, the second switch 42 can be pressed via, for example, the opening portion (not illustrated) that is provided in the bottom portion of the cutter base body 3. Once turned ON, the second switch 42 outputs an ON signal to the controller 34.

The controller 34 adds a count number of 1 to the count value (total number of movements (count number)) and the integrated value (integrated number) in a case where the magnetic sensor 32 outputs a detection signal indicating non-detection of the magnet 30 and the first switch 40 outputs the ON signal in a state where the magnetic sensor 32 outputs a detection signal indicating detection of the magnet 30. In other words, the controller 34 adds a count number of 1 to the count value and the integrated value in a case where the slider 7 reaches the cut initiation position (predetermined position), the fiber holder 15 is set in the holder guide portion 13, and then the slider 7 returns to the initial position (case where the slider 7 moves from the cut initiation position). The controller 34 stores the count value and the integrated value.

The controller 34 displays the count value or the integrated value on the display unit 36. The count value is the value that is counted in a first period. Specifically, the count value is the value that is counted from the initial state or after the implementation of a first reset operation (described later). The integrated value is the value that is counted in a second period. Specifically, the integrated value is the value that is counted from the initial state or after the implementation of a second reset operation (described later) and is a count value-integrated value (count value-including value). The controller 34 displays the count value on the display unit 36 once the ON signal is further received from the second switch 42. The controller 34 displays the integrated value on the display unit 36 once the ON signal is received from the second switch 42 after the count value is displayed on the display unit 36. In other words, the controller 34 alternately displays the count value and the integrated value on the display unit 36 every time the second switch 42 is pressed.

The controller 34 resets the count value once the first reset operation is implemented. Specifically, the controller 34 resets the stored count value when the second switch 42 outputs the ON signal continuously and for a predetermined time or longer (when the second switch 42 is pressed for a long time). The controller 34 resets the integrated value once the second reset operation is implemented. Specifically, the controller 34 resets the stored integrated value when the magnetic sensor 32 outputs a detection signal in a state where the ON signal is output from the second switch 42 and the ON signal is output from the first switch 40 within, for example, five seconds from the detection signal output.

The display unit 36 displays the number of movements of the slider 7 to the cut initiation position calculated by the controller 34. As illustrated in FIG. 1, the display unit 36 is disposed in the front of the cutter base body 3. The display unit 36 is, for example, a liquid crystal display (LCD). The display unit 36 displays the count value or the integrated value on the basis of the display signal that is output from the controller 34. For example, the display unit 36 displays the count value or the integrated value when the slider 7 reaches the cut initiation position or when the fiber holder 15 is set in the holder guide portion 13. The display unit 36 terminates the display after the elapse of a predetermined time from the display of the count value or the integrated value.

The power source 38 supplies electric power to the controller 34 and the display unit 36. The power source 38 is, for example, a battery. The power source 38 supplies electric power to the magnetic sensor 32, the first switch 40, and the second switch 42 via the controller 34.

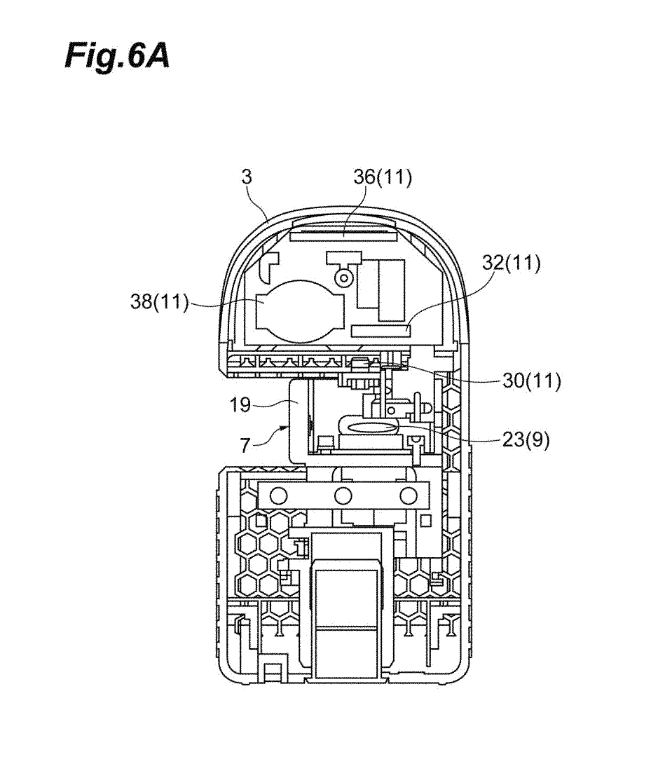

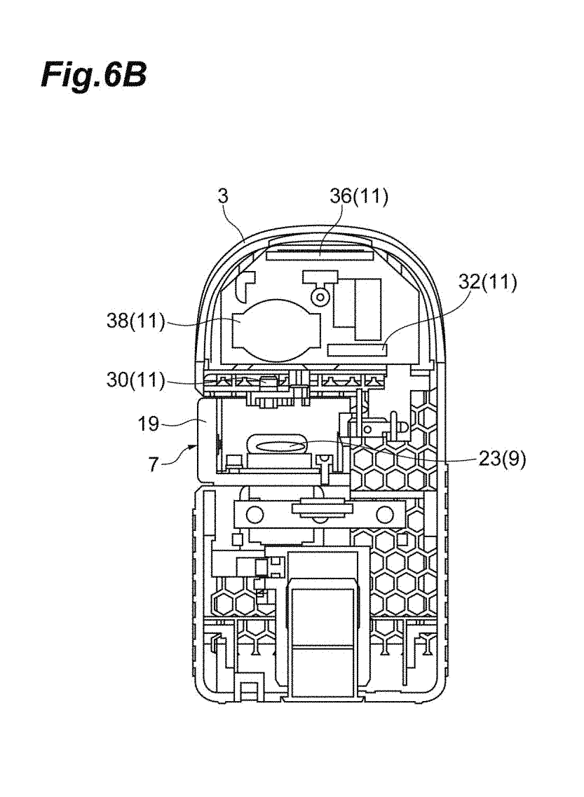

An operation of the count mechanism 11 will be described below. As illustrated in FIG. 6A, in the count mechanism 11, the magnetic sensor 32 detects the magnet 30 provided on the slider 7 once the push-in portion 19 of the slider 7 is pushed in and the slider 7 reaches the cut initiation position. Upon detecting the magnet 30, the magnetic sensor 32 outputs a detection signal indicating the detection of the magnet 30 to the controller 34. Once the detection signal is output from the magnetic sensor 32, the display unit 36 displays, for example, the count value.

In addition, once the fiber holder 15 is set in the holder guide portion 13, the first switch 40 connected to the claw member 17 via the connecting member 44 is turned ON. Once turned ON, the first switch 40 outputs an ON signal to the controller 34. The slider 7 returns to the initial position as illustrated in FIG. 6B once the cutter lid body 5 is closed with respect to the cutter base body 3 and the locked state of the slider 7 with respect to the cutter base body 3 is released. At this time, the magnetic sensor 32 outputs a detection signal indicating non-detection of the magnet 30 to the controller 34.

The controller 34 adds a count number of 1 to the count value and the integrated value in a case where the magnetic sensor 32 outputs a detection signal indicating non-detection of the magnet 30 and the first switch 40 outputs the ON signal in a state where the magnetic sensor 32 outputs a detection signal indicating detection of the magnet 30. The display unit 36 terminates the count value display after the elapse of a predetermined time from the count value display.

A method for cutting the optical fiber 2 by using the optical fiber cutter 1 will be described below. As illustrated in FIG. 7A, the push-in portion 19 of the slider 7 is pushed in first, with the cutter lid body 5 open with respect to the cutter base body 3, when cutting work is performed on the optical fiber 2 by means of the optical fiber cutter 1. Then, the slider 7 moves to the side that is opposite to the open portion 3C (moves to the other side surface 3D side) against the biasing force of the spring 21 and reaches the cut initiation position as illustrated in FIG. 7B. At this time, the slider 7 is held at the cut initiation position by a locking structure (not illustrated) provided on the cutter base body 3.

In addition, by the arm abutting against the rotating body 25, the rotating body 25 rotates by a predetermined amount, and the blade member 23 rotates by a predetermined amount as a result. Accordingly, the part of the blade member 23 that is in contact with the optical fiber 2 is shifted by a predetermined amount every time the slider 7 reaches the cut initiation position.

In this state, the fiber holder 15 holding the optical fiber 2 is set in the holder guide portion 13 of the cutter base body 3 as illustrated in FIG. 1. As a result, the optical fiber 2 is positioned with respect to the slider 7 as illustrated in FIG. 7C.

Next, the cutter lid body 5 is closed with respect to the cutter base body 3. Then, the locked state of the slider 7 with respect to the cutter base body 3 is released by a locking release portion 4 provided on the cutter base body 3 being pressed by the cutter lid body 5. As a result, the slider 7 returns to the initial position (cut completion position) by being moved to the open portion 3C side by the biasing force of the spring 21 as illustrated in FIG. 7D.

At this time, the blade member 23 moves to the open portion 3C side. As a result, the blade member 23 comes into contact with the glass fiber 2A of the optical fiber 2, the glass fiber 2A is scratched by the blade member 23, and the glass fiber 2A is cut.

As described above, in the optical fiber cutter 1 according to the present embodiment, the magnet 30 is detected by the magnetic sensor 32 and the controller 34 calculates the number of movements of the slider 7 to the cut initiation position on the basis of the detection results and stores the calculated number. Since the number of movements of the slider 7 to the cut initiation position is calculated by the controller 34 as described above, the count value can be reset with ease and the integrated value of the count values can be stored. Accordingly, the performance of the optical fiber cutter 1 can be improved with a simple configuration.

In the optical fiber cutter 1 according to the present embodiment, the cutter base body 3 has the holder guide portion 13 defining the position of the fiber holder 15 holding the optical fiber 2. The count mechanism 11 is provided with the first switch 40 detecting disposition of the fiber holder 15 in the holder guide portion 13. In a case where the fiber holder 15 is detected by the first switch 40, the controller 34 calculates the number of movements of the slider 7 to the cut initiation position. In this configuration, the controller 34 calculates the number of movements only when the fiber holder 15 is set in the holder guide portion 13. As a result, the controller 34 does not calculate the number of movements of the slider 7 to the cut initiation position, even if the slider 7 is moved, in a state where the fiber holder 15 is not set in the holder guide portion 13. As a result, it is possible to calculate the number of movements of the slider 7 to the cut initiation position only when the optical fiber 2 is actually cut.

In the optical fiber cutter 1 according to the present embodiment, the claw member 17 moved by the fiber holder 15 when the fiber holder 15 is disposed in the holder guide portion 13 and the first switch 40 energized (ON) or shut off (OFF) in conjunction with the movement of the claw member 17 constitute the holder detector. The controller 34 detects disposition of the fiber holder 15 in the holder guide portion 13 when the claw member 17 is moved by the fiber holder 15 and the first switch 40 is turned ON. In this configuration, the presence or absence of the fiber holder 15 in the holder guide portion 13 can be precisely detected.

In the optical fiber cutter 1 according to the present embodiment, the magnet 30 is provided on the slider 7 and the magnetic sensor 32 is provided on the cutter base body 3. In this configuration, the magnetic sensor 32 requiring wiring or the like is provided on the cutter base body 3, and thus the configuration can be simpler than in a case where a sensor is provided on the slider 7 as a moving body. In addition, since the magnet 30 as an object to be detected is detected by the magnetic sensor 32 in this configuration, the slider 7 reaching the cut initiation position can be precisely detected.

In the optical fiber cutter 1 according to the present embodiment, the controller 34 stores the count value, which is the number of rotations of the blade member 23 in the first period, and stores the integrated value, which is the number of rotations of the blade member 23 in the second period and includes the count value. The display unit 36 displays at least one of the count value and the integrated value. As a result, the count value and the integrated value can be displayed on the display unit 36.

In the optical fiber cutter 1 according to the present embodiment, the blade member 23 is rotatably provided on the slider 7 and rotates by a predetermined angle in one direction when the slider 7 reaches the cut initiation position. As a result, the number of rotations of the blade member 23 resulting from a movement of the slider 7 to the cut initiation position can be calculated.

The present invention is not limited to the above-described embodiment, and various modifications are possible without departing from the gist of the present invention.

In addition to the above-described embodiment, the magnetic sensor 32 may have a shielding member magnetically shielding the part thereof other than the part thereof that faces the magnet 30. The shielding member is a shield material formed of, for example, a magnetic metal such as iron, cobalt, and nickel, an alloy containing these metals, or a member containing these. Although the most preferable in this case is shielding of the entire part that does not face the magnet 30, the part that does not face the magnet 30 may be partially shielded as well. Then, the magnetic sensor 32 is unlikely to be affected by a magnetic field other than the magnet 30. Accordingly, the magnetic sensor 32 is capable of precisely detecting the magnet 30. As a result, the number of movements of the slider 7 to the predetermined position can be accurately calculated.

The magnet 30 has been exemplified as an object to be detected and the magnetic sensor 32 has been exemplified as a sensor in the above-described embodiment. However, the object to be detected and the sensor are not limited thereto insofar as the object and the sensor are for non-contact detection. For example, the object to be detected may be a mirror and the sensor may be a light emitting and receiving sensor instead.

In the above-described exemplary embodiment, the magnet 30 is provided on the slider 7 and the magnetic sensor 32 is provided on the cutter base body 3. However, the magnet 30 may be provided on the cutter base body 3 and the magnetic sensor 32 may be provided on the slider 7.

In the above-described exemplary embodiment, the controller 34 causes either one of the count value and the integrated value to be displayed on the display unit 36. The display unit may display both the count value and the integrated value depending on the type of the display unit.

In the above-described exemplary embodiment, a count number of 1 is added to the count value and the integrated value in a case where the magnetic sensor 32 outputs a detection signal indicating non-detection of the magnet 30 and the first switch 40 outputs the ON signal in a state where the magnetic sensor 32 outputs a detection signal indicating detection of the magnet 30. However, the controller 34 may add a count number of 1 to the count value and the integrated value in a case where the magnetic sensor 32 outputs a detection signal indicating non-detection of the magnet 30 after the magnetic sensor 32 outputs a detection signal indicating detection of the magnet 30. In other words, the first switch 40 is optional.

In the above-described exemplary embodiment, the first switch 40 is energized (turned ON) in conjunction with a movement of the claw member 17 when the fiber holder 15 is disposed in the holder guide portion 13. However, the first switch 40 may be shut off (turned OFF) in conjunction with a movement of the claw member 17. In this case, the controller 34 adds a count number of 1 to the count value and the integrated value in a case where a detection signal is output from the magnetic sensor 32 with no ON signal output from the first switch 40.

The power source 38 is a battery in the above-described exemplary embodiment. However, the power source 38 is not limited thereto insofar as the power source 38 is capable of supplying electric power to each part. For example, the power source 38 may also be a device supplying each part with electric power supplied from the outside.

In the above-described exemplary embodiment, the disk-shaped blade member 23 is rotatably provided on the slider 7. However, the shape of the blade member is not limited to the disk shape and the blade member may also be a non-rotating blade member.

### REFERENCE SIGNS LIST

1: optical fiber cutter, 2: optical fiber, 3: cutter base body, 7: slider, 13: holder guide portion, 15: fiber holder, 17: claw member (holder detector, moving portion), 23: blade member, 30: magnet (object to be detected, magnetic body), 32: magnetic sensor (sensor), 34: controller, 36: display unit, 40: first switch (holder detector, electric contact point).

1: An optical fiber cutter cutting an optical fiber, the optical fiber cutter comprising:
a cutter base body;
a slider movably provided on the cutter base body;
a blade member provided on the slider;
an object to be detected provided on either one of the cutter base body and the slider;
a sensor provided on the other of the cutter base body and the slider and detecting the object to be detected;
a controller that, on the basis of the detection results of the sensor, calculates the number of movements of the slider to a predetermined position and stores the calculated number; and
a display unit that displays the number of movements calculated by the controller.

2: The optical fiber cutter according to claim 1, wherein:
the cutter base body includes a holder guide portion defining a position of a fiber holder holding the optical fiber;
a holder detector is provided for detection of disposition of the fiber holder in the holder guide portion; and
the controller calculates the number of movements of the slider to the predetermined position in a case where the fiber holder is detected by the holder detector.

3: The optical fiber cutter according to claim 2, wherein:
the holder detector has a moving portion moved by the fiber holder when the fiber holder is disposed in the holder guide portion and an electric contact point energized or shut off in conjunction with the movement of the moving portion; and
the disposition of the fiber holder in the holder guide portion is detected when the electric contact point is energized or shut off.

4: The optical fiber cutter according to claim 1, wherein:
the object to be detected is provided on the slider; and
the sensor is provided on the cutter base body.

5: The optical fiber cutter according to claim 1, wherein:
the controller stores a count value as the number of movements of the slider to the predetermined position in a first period and stores an integrated value as the number of movements of the slider to the predetermined position in a second period including the count value; and
the display unit displays at least one of the count value and the integrated value.

6: The optical fiber cutter according to claim 1, wherein:
the object to be detected is a magnetic body; and
the sensor is a magnetic sensor.

7: The optical fiber cutter according to claim 6, wherein the sensor has a shielding member magnetically shielding a part other than a part facing the object to be detected.

8: The optical fiber cutter according to claim 1, wherein the blade member is rotatably provided on the slider and rotates by a predetermined angle in one direction when the slider reaches the predetermined position.
